(19) United States
(12) Patent Application Publication
(10) Pub. No.: US 2025/0079101 A1
(43) Pub. Date: Mar. 6, 2025

(54) MAGNETIC SWITCH FOR HYBRID CIRCUIT BREAKER APPLICATIONS

(71) Applicant: Siemens Industry, Inc., Alpharetta, GA (US)

(72) Inventors: James Edward Ferree, Lawrenceville, GA (US); Guang Yang, Johns Creek, GA (US)

(73) Assignee: Siemens Industry, Inc., Alpharetta, GA (US)

(21) Appl. No.: 18/240,790

(22) Filed: Aug. 31, 2023

(51) Int. Cl. H01H 50/44; H01H 50/18; H01H 50/54; H01H 71/10

(52) U.S. Cl. CPC H01H 50/44; H01H 50/18; H01H 50/54; H01H 71/10

(57) ABSTRACT

A magnetic switch comprises a frame and one or more driver coil assemblies, including one or more driver coils, attached to the frame. The magnetic switch also comprises a movable coil assembly, including a movable coil and a rotor. The one or more driver coil assemblies and the movable coil assembly are arranged such that a magnetic field generated when current flows through the one or more driver coils of the one or more driver coil assemblies and the movable coil of the movable coil assembly generates a magnetic force that acts on the movable coil assembly in a direction to produce rotational torque of the rotor mounted to the movable coil assembly to cause actuation of the magnetic switch.

### TECHNICAL FIELD

The present disclosure relates generally to mechanical switches for hybrid circuit breaker applications.

### BACKGROUND

Circuit breakers are typically used to protect downstream circuits and equipment in various environments, such as residential homes or buildings, hospitals, industrial settings such as factories, etc., in case of a fault, such as in an overcurrent or a short circuit situation. Generally, circuit breakers carry current from a power supply to a load under normal operating conditions and break, or extinguish, the current in order to protect the load under fault conditions, for example when rising current due to a short circuit is detected. Types of circuit breakers include mechanical circuit breakers and solid-state circuit breakers (SSCBs). Mechanical circuit breakers interrupt flow of current by separation of mechanical contacts. Because of inductive energy in the circuit, an arc forms between the contacts. The electrical resistance of the arc causes voltage that opposes system voltage and eventually stops the flow of current. Solid-state circuit breakers (SSCSs), on the other hand, use semiconductor switching elements to open a circuit and interrupt flow of the current.

Mechanical circuit breakers are generally slower in interrupting current as compared to solid-state circuit breakers. In a typical mechanical circuit breaker, several milliseconds are required to interrupt the circuit, ranging from about 2 to 16 milliseconds. During this time, a short circuit current can rise to a very high level, and the resultant let-though current and joule energy may stress downstream circuits and equipment. Further, mechanical circuit breakers suffer from heat erosion due to the arc, which leads to a reduced life span of a typical mechanical circuit breaker. SSCBs, on the other hand, have no arcing and may produce nearly instantaneous interruption of current flow thereby preventing damaging let-through currents. However, SSCBs may be more expensive than mechanical circuit breakers. Further, SSCBs generate considerably greater amounts of heat as compared to mechanical circuit breakers. As a result, SSCBs are often less efficient than mechanical circuit breakers. In various applications, more and larger mechanical circuit breakers can be installed in the same size enclosure, relative to SSCBs, without exceeding allowable temperature limits.

Recently, hybrid circuit breakers have been proposed. Hybrid circuit breakers work by providing two parallel electrical paths: a continuous current path and a bypass circuit. The continuous current path is low resistance and comprises a commutation switch. In the event of a fault, the commutation switch opens and diverts current to the bypass circuit. The bypass circuit contains a solid-state interrupter that can interrupt the current.

A hybrid breaker combines the advantages of low heat production of a mechanical breaker and fast interruption, reduced arcing and reduced let-through current of an SSCB. In addition, the semiconductor components of a hybrid circuit breaker may have reduced cost in comparison to an SSCB. Hybrid circuit breakers do not require continuous current flowing through semiconductor switching components, and therefore the semiconductor components do not have to be as large or fewer semiconductor components may be used in parallel as compared to SSCB.

However, practical use of hybrid circuit breakers is limited due at least in part to inability of current commutation switches to sufficiently quickly commutate current from the continuous current path to the bypass circuit so that current may be interrupted before the current rises to levels that can damage the semiconductor components of the hybrid circuit breakers and/or generate let-through currents that can damage circuits and equipment being protected by the hybrid circuit breaker.

### SUMMARY

Embodiments of the present disclosure provide a magnetic switch suitable for use as a mechanical switch in a continuous current path of a hybrid circuit breaker. In an embodiment, the magnetic switch is equipped with one or more driver coil assemblies and a movable coil assembly. The one or more driver coil assemblies and the movable coils assembly are arranged such that magnetic force generated when current flows through one or more coils of the one or more driver coil assemblies acts on a coil of the movable coil assembly, causing rotation of a rotor that is mounted to the movable coil assembly. Rotation of the rotor causes opening and closing of the magnetic switch. The magnetic forces generated in such arrangement of the magnetic switch may be sufficiently strong to result in a sufficiently fast opening time of the magnetic switch. The magnetic switch may thus be opened sufficiently quickly to commutate current to a bypass current path of a hybrid circuit breaker, so that current may be extinguished in the bypass current path of the hybrid circuit breaker before the current rises to a high level, in at least some embodiments.

In an embodiment, a magnetic switch is provided. The magnetic switch comprises a frame and one or more driver coil assemblies, including one or more driver coils, are attached to the frame. The magnetic switch also comprises a movable coil assembly, including a movable coil and a rotor. The one or more driver coil assemblies and the movable coil assembly are arranged such that a magnetic field generated when current flows through the one or more driver coils of the one or more driver coil assemblies and the movable coil of the movable coil assembly generates a magnetic force that acts on the movable coil assembly in a direction to produce rotational torque of the rotor mounted to the movable coil assembly to cause actuation of the magnetic switch.

In another embodiment, a hybrid circuit breaker is provided. The hybrid circuit breaker includes a first current path configured to conduct current from a power supply to a load under normal operating conditions, and a second current path configured as a bypass current path to which the current is diverted when a fault is detected. The hybrid circuit breaker also includes a solid-state switch in the second current path configured to extinguish the current diverted to the second current path. The hybrid circuit breaker additionally includes a magnetic switch configured to operate in a closed position to conduct the current from the power supply to the load, and switch to an open position to when the fault is detected. The magnetic switch includes one or more driver coil assemblies, the one or more driver coil assemblies including one or more driver coils, and a movable coil assembly, the movable coil assembly including a movable coil. The magnetic switch also includes a rotor mounted on the movable coil assembly. The one or more driver coil assemblies and the movable coil assembly are arranged such that a magnetic field generated when current flows through the one or more driver coils of the one or more driver coil assemblies and the movable coil of the movable coil assembly and generate a magnetic force that acts on the movable coil assembly in a direction to produce rotational torque of the rotor mounted to the movable coil assembly to cause the magnetic switch to switch from the closed position to the open position when the fault is detected.

Other systems, methods, and/or features of the present embodiments will become apparent to one with skill in the art upon examination of the following Figs. and detailed description. It is intended that all such additional systems, methods, features, and advantages be included within this description, be within the scope of the invention, and be protected by the accompanying claims. Additional features of the disclosed embodiments are described in, and will be apparent from, the following detailed description and the Figs.

### BRIEF DESCRIPTION OF THE FIGURES

The components in the Figs. are not necessarily to scale, emphasis instead being placed upon illustrating the principles of the embodiments. In the Figs., like reference numerals designate corresponding parts throughout the different views.

FIG. 1 is a block diagram of a hybrid circuit breaker in which a magnetic switch equipped with a movable coil assembly and one or more driver coil assemblies may be utilized, according to an embodiment.

FIG. 2 is a block diagram of another hybrid circuit breaker in which a magnetic switch equipped with a movable coil assembly and one or more driver coil assemblies may be utilized, according to another embodiment;

FIG. 3A is a plot illustrating rise in current under a fault condition, according to an embodiment.

FIG. 3B is a diagram illustrating timing of operation of a hybrid circuit breaker under the fault condition illustrated in FIG. 3A, according to an embodiment.

FIG. 4 is a view illustrating a magnetic switch equipped with a movable coil assembly and one or more driver coil assemblies, according to an embodiment.

FIG. 5 is a view illustrating components of the magnetic switch of FIG. 4, according to an embodiment.

FIG. 6 is another view illustrating components of the magnetic switch of FIG. 4, according to an embodiment.

FIG. 7 is an expanded view of a driver coil assembly that may be utilized in the magnetic switch of FIG. 4, according to an embodiment.

FIG. 8 is a view of a rotor assembly that may be utilized in the magnetic switch of FIG. 4, according to an embodiment.

FIG. 9 is an expanded view of a moving coil assembly that may be utilized in the magnetic switch of FIG. 4, according to an embodiment.

FIG. 10A is a view of a cut section through the middle of the magnetic switch of FIG. 4 in the closed position, according to an embodiment.

FIG. 10B is a side view showing the direction of flow of current in coils of the magnetic switch of FIG. 4 and the resulting magnetic forces as the magnetic switch transitions from the closed position to an open position, according to an embodiment.

FIG. 11A is a view of a cut section through the middle of the magnetic switch of FIG. 4 in the open position, according to an embodiment.

FIG. 11B is a side view showing the direction of flow of current in coils of the magnetic switch of FIG. 4 and the resulting magnetic forces as the magnetic switch reaches the open position, according to an embodiment.

FIG. 12 is a simulation plot that illustrates torque produced for actuating the magnetic switch 400 of FIG. 4, according to an embodiment.

FIG. 13 is a table 1300 illustrating rotational inertias and switch opening times for the magnetic switch 400 of FIG. 4, according to an embodiment.

FIG. 14 is a simulation plot illustrating magnetic field intensity crossing the movable coil assembly when coils of the one or more driver coil assemblies and the movable coil assembly are energized in the magnetic switch of FIG. 4, according to an embodiment.

FIG. 15 is a simulation plot illustrating magnetic flux density crossing the movable coil assembly when coils of the one or more driver coil assemblies and the movable coil assembly are energized in the magnetic switch of FIG. 4, according to an embodiment.

FIG. 16 is a block diagram of a hybrid circuit breaker equipped with a mechanical switch, such as the magnetic switch of FIG. 4, in a continuous current path, according to an embodiment.

FIG. 17 is a block diagram of a hybrid circuit breaker equipped with a mechanical switch, such as the magnetic switch of FIG. 4, in a continuous current path, according to another embodiment.

FIG. 18 is a block diagram of a hybrid circuit breaker equipped with a mechanical switch, such as the magnetic switch of FIG. 4, in a continuous current path, according to yet another embodiment.

FIG. 19 is a block diagram of a hybrid circuit breaker equipped with a mechanical switch, such as the magnetic switch of FIG. 4, in a continuous current path, according to still another embodiment.

### DESCRIPTION OF SOME EMBODIMENTS

In embodiments described below, a magnetic switch having a relatively quick opening time is provided. The magnetic switch is equipped with a plurality of coil assembles, including one or more driver coil assemblies and a movable coils assembly. The one or more driver coil assemblies and the movable coils assembly are arranged such that magnetic force generated when current flows through one or more coils of the one or more driver coil assemblies and a coil of the movable coil assembly act upon the movable coil assembly in a direction that causes rotation of a rotor that is mounted to the movable coil assembly. Rotation of the rotor causes opening and closing of the magnetic switch. As explained in more detail below, magnetic forces generated in such an arrangement of the magnetic switch may be sufficiently strong to result in a sufficiently fast opening time of the magnetic switch. The intensity of the magnetic field generated by the one or more driver coils and the resulting force exerted on the movable coil may be controlled by the size and the number of windings in the driver coils and the movable coil. Generally, the intensity of the magnetic field generated by the one or more driver coils may be greater than a magnetic field that can be generated by other magnetic structures, such as permanent magnets, in place of the driver coils. Greater magnetic field and the resulting greater force exerted on the movable coil assembly results in faster opening time of the magnetic switch as compared to other magnetic switches in which permanent magnets are used. For example, as described in more detail below, an opening time that is equal to or less than 100 μs or less than 200 μs (or another opening time on the order of 100s of μs, for example) may be achieved.

In an embodiment, the magnetic switch described herein is used as a mechanical switch in a continuous current path of a hybrid circuit breaker. The magnetic switch may have a sufficiently quick opening time to ensure that, under a fault (e.g., short circuit) condition, fault current is quickly commutated to, and extinguished in, a bypass current path of the hybrid circuit breaker before current rises to a high level. For example, due to the fast opening time of the magnetic switch, fault current may be extinguished in the bypass current path of the hybrid circuit breaker at a level that is at least approximately equal to a threshold level at which the current is determined to be due to a fault and not due to a transient inrush current, for example. In various embodiments, the magnetic switch described herein allows for practical use hybrid circuit breakers, particularly in low to medium voltage circuit breaker applications. However, although the magnetic switch is generally described herein in the context of a hybrid circuit breaker, the disclosure is not so limited, and the magnetic switch may be utilized in other suitable applications in other embodiments.

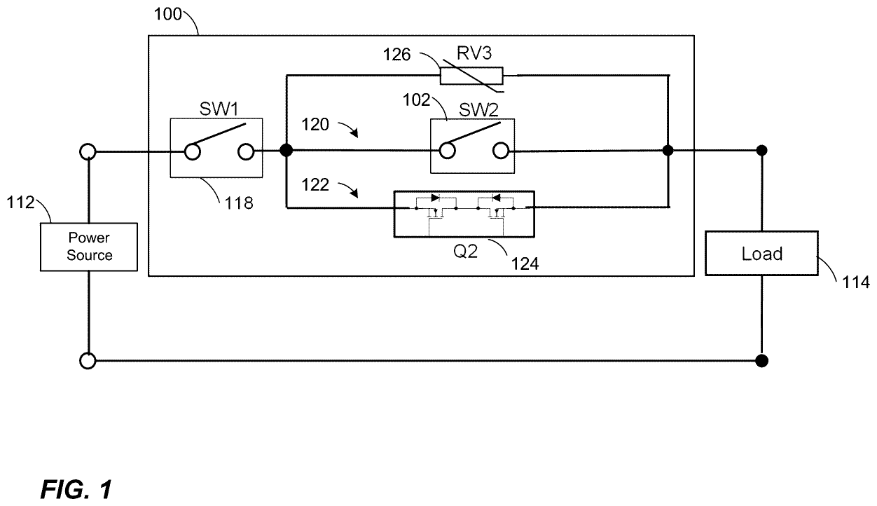

FIG. 1 is a block diagram of an example hybrid circuit breaker 100, according to an embodiment. The hybrid circuit breaker 100 may be coupled between a source 112 and a load 114 and may generally be configured to conduct current from the source 112 and the load 114 under normal operating condition, and interrupt or break the current under a fault condition, such as a current overload or a short circuit condition. The hybrid circuit breaker 100 may be configured for use in low voltage (e.g., less than or equal to 1000 V) circuit breaker applications, such as residential house or apartment building application. In such applications, the hybrid circuit breaker 100 may be configured to have a short circuit rating of up to 10,000-20,000 Amperes (A). In some embodiments, the hybrid circuit breaker 100 may be used in other low voltage applications, such as commercial and/or industrial low voltage applications. In such applications, the hybrid circuit breaker 100 may be configured to have a short circuit rating of up to 200,000 A. The hybrid circuit breaker 100 includes a continuous current path 120, including a mechanical switch 102, and a bypass current path 122, including a solid-state switch 124. The mechanical switch 102 in the continuous current path 120 may be a commutation switch configured to commutate current from the continuous current path 120 to the bypass current path 122 when a fault, such as a short circuit, is detected. The solid-state switch 124 may comprise one or more semiconductor devices, such as one or more metal oxide silicon field effect transistor (MOSFET) devices or other suitable transistors. The solid-state switch 124 in the bypass current path 122 may be configured to extinguish current when current is commutated from the continuous current path 120 to the bypass current path 122.

The mechanical switch 102 may be equipped with one or more driver coil assemblies and a movable coil assembly, and may be configured to be actuated by magnetic forces generated when current is flowing through coils in the one or more driver coil assemblies and the movable coil assembly. As described in more detail below, in this configuration, sufficiently strong magnetic forces may be generated to result in a relatively fast opening time, such as an opening time of 100 μs or less, of the mechanical switch 102, in various embodiments. In some embodiments, the hybrid circuit breaker 100 may additionally include a transient voltage suppressor 126 (e.g., a diode) provided in parallel with the continuous current path 120 and configured to protect the load 114 from transient voltage spikes, for example. In other embodiments, the hybrid circuit breaker 100 may omit the transient voltage suppressor 126.

With continued reference to FIG. 1, under normal operating conditions, the mechanical switch 102 in the continuous current path 120 is operated in a closed position and the solid-state switch 124 in the bypass current path 122 is operated in an OFF state. Accordingly, under normal operating conditions, the hybrid circuit breaker 100 conducts current from the power source 112 to the load 114 via the continuous current path 120. When a fault, such as a short circuit, is detected, the solid-state switch 124 in the bypass current path 122 is switched to a closed position and the mechanical switch 102 in the continuous current path 120 is switched to an open position. Because the mechanical switch 102 in the continuous current path 120 is switched to the open position under load, i.e., as current is flowing in the continuous current path 120 flows through the magnetic switch 120, opening of the mechanical switch 120 generates an arc is the mechanical switch 102. The arc may be sufficiently large to create enough resistance in the continuous current path 120 to divert the current to the bypass current path 122. For example, the magnetic switch 120 may be configured to generate an arc that is just higher than a voltage (e.g., 5V) of the solid-state switch 124 in the bypass current path 122. Accordingly, current is diverted from the continuous current path 120 to the bypass current path 122. Subsequently, the solid-state switch 124 in the bypass current path 122 is switched to an OFF state to extinguish the current. Thus, the load 114 may be protected.

In an embodiment, because under normal operating conditions current flows through the mechanical switch 102 and does not flow through the solid-state switch 124, less heat is generated in the circuit breaker 100 as compared to circuit breakers in which current continuously flows through a solid-state switch, in an embodiment. Further, because current flows through the solid-state switch 124 only briefly when a fault is detected, the solid-state switch 124 may be relatively smaller and cheaper as compared to circuit breakers in which current continuously flows through a solid-state switch, in an embodiment.

Generally, the opening time of the mechanical switch 102 in the hybrid circuit 100 determines a level to which a current will rise after a fault is detected and before current is diverted to the bypass current path 122 and extinguished by the solid-state switch 124 in the bypass current path 122. A relatively slow opening time of the mechanical switch 102 may result in a high let-through current to the load 114, which may damage the load 114 when a fault is detected. Further, with a relatively slow opening time of the mechanical switch 102, a relatively larger solid-state switch 124 may be needed to extinguish the resulting higher level of current diverted to the bypass current path 122. In various embodiments, the mechanical switch 102 is configured as described herein to provide sufficiently fast opening time such that the current is extinguished relatively quickly before the current rises to a high level. The mechanical switch 102 may be equipped with a plurality of coils arranged to generate a high-level magnetic field capable of quickly actuating the mechanical switch 102 when a fault is detected. In an embodiment, the mechanical switch 102 may be equipped with a movable coil assembly and one or more driver coil assemblies arranged such that magnetic flux generated when current flows through coils of the one or more driver coil assemblies crosses a coil of the movable coil assembly, causing rotation of a movable coil assembly rotor between an open position and a closed position of the mechanical switch 102. Example embodiments of the mechanical switch 102 equipped with a movable coil assembly and one or more driver coil assemblies are described in more detail below.

As explained in more detail below, in various embodiments, the mechanical switch 102, when actuated by magnetic forces generated by current flowing through the one or more driver coil assemblies and the movable coil assembly, may achieve a relatively fast opening time as compared to conventional mechanical switches currently used in circuit breaker applications. For example, an opening time equal to or less than 100 μs may be achieved. Due to the relatively fast opening time of the mechanical switch 102, the mechanical switch 102 may open fast enough to commutate the current to the bypass current path 122 so that the current may be extinguished by the solid-state switch 124 in the bypass current path 122 before the current rises to a high value. For example, the mechanical switch 102 may open fast enough to commutate the current to the bypass current path 122 when the current is not higher than about 850 A or another suitable value that may be appropriate for the system in which the circuit breaker 100 may be utilized, in various embodiments.

With continued reference to FIG. 1, the hybrid circuit breaker 100 also includes an additional switch 118. The additional switch 118 may be a mechanical switch that functions as an isolation switch. For example, the additional switch 118 may be switched to an open position after current is extinguished by the solid-state switch 124 in the hybrid circuit breaker 100, to provide galvanic isolation in the hybrid circuit breaker 100, in an embodiment. Accordingly, the additional switch 118 is sometimes referred to herein as an “isolation switch” 118. In at least some embodiments, the isolation switch 118 is configured to also function as a backup switch in the hybrid circuit breaker 100. For example, the additional switch 118 may be actuated to transition to an open position to extinguish the current in case the mechanical switch 102 and/or the solid-state switch 124 of the circuit breaker 100 are not properly functioning. In order to provide backup functionality for the hybrid circuit breaker 100, the isolation switch 118 may be configured to have load breaking capability. In some embodiments, the additional switch 118 may be omitted from the hybrid circuit breaker 100.

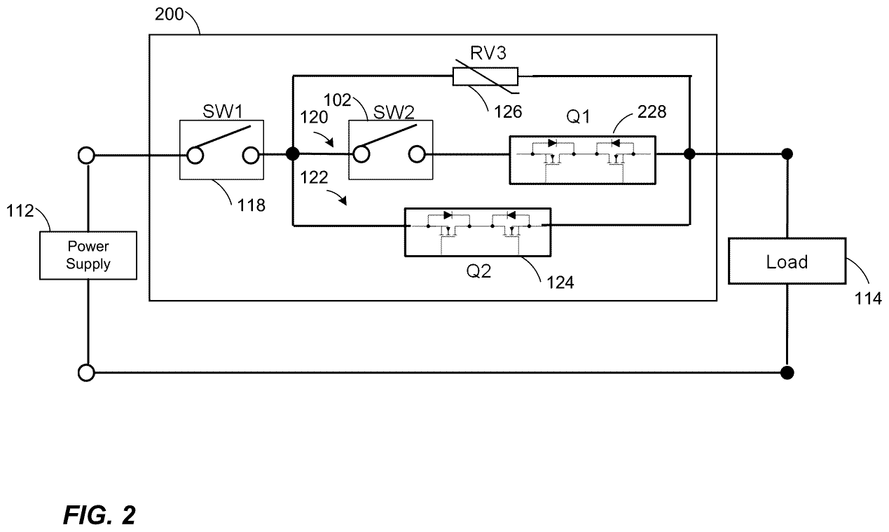

FIG. 2 is a block diagram of another example hybrid circuit breaker 200 in which a magnetic switch device equipped with one or more driver coil assemblies and a movable coil assembly may be utilized, according to another embodiment. The hybrid circuit breaker 200 is generally the same as the hybrid circuit breaker 100 of FIG. 1, except that in the hybrid circuit breaker 200, the continuous current path 120 includes a solid-state switch 228 provided in series with the mechanical switch 102. The solid-state switch 228 may function as a commutation switch in the hybrid circuit breaker 200. Under normal operation, the mechanical switch 102 and the solid-state switch 228 in the continuous current path 102 are both operated in a closed position, and the solid-state switch 124 in the bypass current path 122 is operated in an OFF state. When a fault (e.g., a short circuit) condition is detected, the solid-state switch 228 is switched to the OFF state. Accordingly, current is quickly commutated from the continuous current path 120 to the bypass current path 122. Subsequently, the solid-state switch 228 in the bypath current path 122 is switched to the OFF state to extinguish the current is the bypath current path 122. The solid-state switch 228, however, may not be designed to withstand full voltage of the power source 112. For example, the solid-state switch 228 may be designed with a lower withstand voltage as compared to the full voltage of the power source 112. Because the solid-state switch 228 is designed with a lower withstand voltage, the solid-state switch 228 has a lower resistance in the ON state as compared to a solid-state switch that is designed to withstand full voltage of the power source 112. As a result, the continuous current path 120 is a low resistance path that produces a relatively low amount of heat under normal operating conditions when current flows through the continuous current path 120. In an embodiment, because the solid-state switch 228 is not designed to withstand full voltage of the power source 112, after the solid-state switch 228 is switched to the OFF state and the current is diverted from the continuous current path 120 to the bypass current path 122 and before the current is extinguished in the bypass current path 122, the mechanical switch 102 is switched to the open position to protect the solid-state switch 228 from the full voltage that is applied from the power source 112 to continuous current path 120 after current is extinguished in the bypass current path 122.

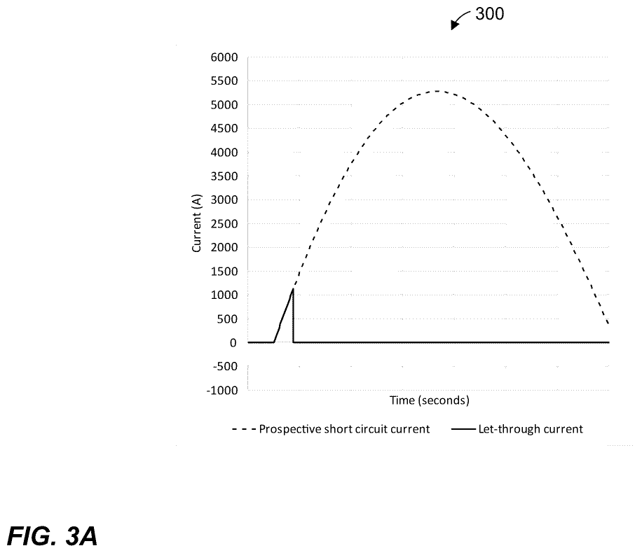

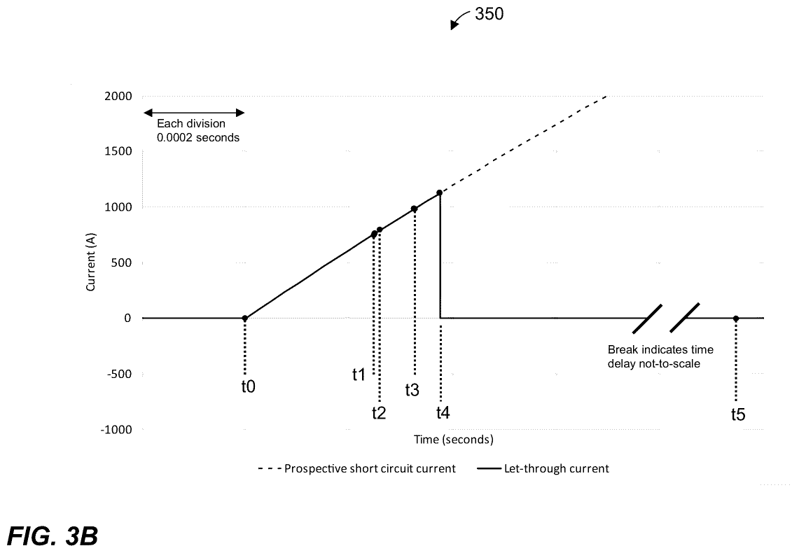

Because current is commutated to the bypass current 122, the mechanical switch 102 is opened under zero-current or low current conditions. Thus, no arc or only a relatively low arc is generated when the mechanical switch 102 is opened. Because the mechanical switch 102 is opened under zero-current or low current conditions and no arc, or only a relatively low arc, is generated, the mechanical switch 102 used in the configuration of the hybrid circuit breaker 200 may have a longer lifetime as compared to when the mechanical switch 102 used in the configuration of the hybrid circuit breaker 200 of FIG. 1. Generally, the mechanical switch 102 needs to be opened before the current can be extinguished in the bypass current path 122 in order to protect the solid-state switch 228 in the continuous current path 120 from a full system voltage (e.g., 240V). Thus, similar to the configuration of the hybrid circuit breaker 100 of FIG. 1, with a relatively slow opening time of the mechanical switch 102 may lead to the current rising to a relatively higher level before the current can be extinguished in the bypass current path 122. Accordingly, with a relatively slow opening time of the mechanical switch 102, a relatively larger solid-state switch 124 may be needed to extinguish the resulting higher level of current diverted to the bypass current path 122. Timing of operation of a circuit breaker such as the circuit breaker 200 under a fault condition, according to an embodiment, is described in more detail below in connection with FIGS. 3A-B.

In various embodiments, the mechanical switch 102 configured as described herein may provide sufficiently fast opening time such that the current is extinguished relatively quickly before the current rises to a high level. For example, current may be extinguished at or near a threshold current value (e.g., 850 A) that indicates that the current is due to a fault and not a transient, such as an inrush, current. As a result, let-through current that can potentially damage circuits and equipment being protected by the hybrid circuit breaker 200 may be eliminated or reduced as compared to let-through current of a hybrid circuit breaker in which a slower mechanical switch is used, in at least some embodiments. Also, in at least some embodiments, the solid-state switch 124 may be smaller (e.g., include smaller and/or fewer semiconductor components) and cheaper as compared to solid-state switches used in a bypass path of a hybrid circuit breaker in which a slower mechanical switch is used.

FIGS. 3A-B are plots 300, 350 illustrating rising current flowing through a hybrid circuit breaker under a fault condition and a timeline of the current being extinguished by the circuit breaker, according to an embodiment. The plots 300, 350 may apply to circuit breakers in which a magnetic switch equipped with a movable coil assembly and one or more driver coil assemblies may be utilized to quickly commute rising current from a continuous current path to a bypass current path, so that the current can be quickly extinguished by a solid-state switch in the bypass current path, in various embodiments. For ease of explanation, the plots 300, 350 are described in connection with the hybrid circuit breaker 200 of FIG. 2. In other examples, same or similar plots may apply to circuit breakers different from the hybrid circuit breaker 200 of FIG. 2. For example, similar plots apply to the hybrid circuit breaker 100 of FIG. 1, in some embodiments.

Referring briefly to FIG. 3A, a dashed line in the plot 300 represents prospective short circuit current rising from zero to a maximum value. The maximum value of short current is 5500 A occurring 4 ms after the shot circuit begins, in the illustrated example. A solid line in the plot 300 represents the let-through current of the hybrid circuit breaker 200. As shown by the solid line graph, the hybrid circuit breaker 200 interrupts the current relatively quickly, not allowing the current to reach the maximum value, in an embodiment.

Referring now to FIG. 3B, a plot 350 illustrates a zoomed-in area of the plot 300 of FIG. 3A. The zoomed-in area illustrated in the plot 350 shows a timeline according to which the let-through current is interrupted and brought to zero by the hybrid circuit breaker 200, in an embodiment. In particular, at a time t₀, the short circuit begins and current flowing through the hybrid circuit breaker 200 begins rising. Time t₁ occurs after the short circuit begins at to and corresponds to a time at which the current has risen to a threshold value that signifies that the rising current should be interrupted by the hybrid circuit breaker 200. The threshold value may be set to a value that indicates that the rising current is due to a fault, such as a short circuit, and not another cause, such as an inrush current resulting from an appliance being turned on, for example. In the embodiment of FIGS. 3A-B, the threshold value is set to 850 A. In other embodiments, other suitable threshold values may be utilized.

At a time t₁, when the current has risen to the threshold value, a control signal is provided to the solid state switch 228 in the continuous current path 120 to switch the solid state switch 228 to an OFF state. Opening of the solid state switch 228 at the time t₁ diverts the current from the continuous current path 120 to the bypass current path 122. At a time t₂, the mechanical switch 102 in the continuous current path 120 is actuated to switch the open position. At a time t₃, the mechanical switch 102 reaches the fully open position. In an embodiment, t₂ occurs a small time increment Δt after the solid state switch 228 is opened at the time t₁ (t₂=t₁+Δt). In an embodiment, because current is diverted from the continuous current path 120 to the bypass current path 122 at the time t₁, the mechanical switch 102 is opened under zero current, or nearly zero current, conditions.

At a time t₄, a control signal is provided to the solid-state switch 124 in the bypass current path 120 to switch the solid-state switch 124 to an OFF state. Switching the solid-state switch 124 to the OFF state interrupts the current flowing through the hybrid circuit breaker 200, cutting the let-through current to zero or nearly zero, in an embodiment. At a time t₅, the isolation switch 118 is switched to an open position. The time t₅ may not occur until a certain time duration, such as several milliseconds, after interruption of the current in the bypass current path 120 due to the amount of time needed for a spring mechanism of the isolation switch 118 to respond to the actuation of the isolation switch 118 after interruption of the current in the bypass current path 120.

Generally, after opening of the solid-state switch 124 in the bypass current path 122, current is extinguished by the solid-state switch 124 in the bypass current path 122, and full system voltage (e.g., 240V) returns to the continuous current path 120. However, the solid state switch 228 in the continuous current path 120 may not designed to withstand full system voltage. For example, the solid state switch 228 in the continuous current path 120 may be made of smaller and cheaper semiconductor components that may not be rated to withstand the full system voltage. Thus, opening of the solid-state switch 124 is not initiated until after the magnetic switch 120 in the continuous current path 120 reached the open position at the time t₃, in an embodiment. Accordingly, a relatively faster mechanical switch 102 in the continuous current path 120 allows for the solid-state switch 124 in the bypass current path 122 to be opened relatively quickly after current is diverted to the bypass current path 122 and before the current reaches a high level.

The mechanical switch 102 equipped with a movable coil and one or more driver coils in accordance with embodiments of the preset disclosure may achieve a relatively fast opening time such that the time t₃ at which the magnetic switch reaches the open position and, accordingly, the time t₄ at which opening of the solid-state switch 124 in the bypass current path 122 is initiated, may occur relatively soon, such as 100 μs, after the current has risen to the threshold level and is diverted to the bypass current path 122, in various embodiments. Thus, the current may be extinguished by the solid-state switch 124 before the current reaches a high level. Accordingly, because the solid-state switch 124 does not need to break current at high level, such as a level significantly higher than the threshold level, the solid-state switch 124 may be made relatively smaller and cheaper as compared to solid-state switches in circuit breakers in which relatively slower opening time (e.g., on the order of ms) mechanical switches in the continuous current path are utilized.

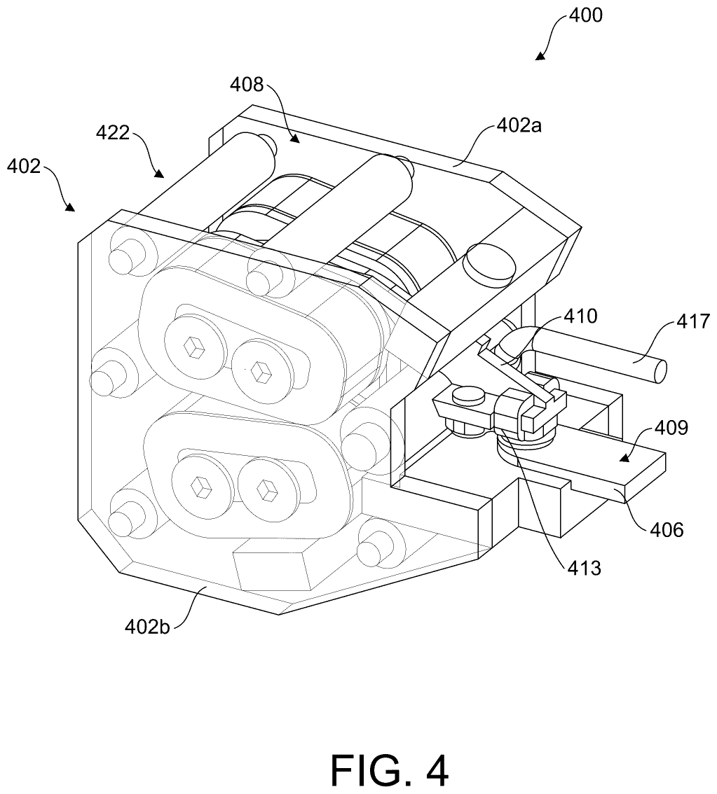

FIGS. 4-6 are views showing a magnetic switch 400 equipped with a movable coil assembly and one or more driver coil assemblies, according to an embodiment. The movable coil assembly and the one or more driver coil assemblies are arranged such that magnetic fields generated when current flows through coils of the one or more driver coil assemblies result in a magnetic force acting on, and causing movement of, the movable coil assembly. Movement of the movable coil assembly causes a rotor to rotate between an opened and a closed position of the magnetic switch 400. In an embodiment, the movable coil assembly and the one or more driver coil assembly are configured to produce a sufficiently large magnetic force to result in fast opening time of the magnetic switch 400. In an embodiment, a relatively faster opening time may be achieved as compared to magnetic switches in which permanent magnets are utilized. For example, in an embodiment, an opening time that is less than or equal to 100 μs may be achieved.

The magnetic switch 400 may be utilized in a hybrid circuit breaker application in which a mechanical switch having a fast opening time in a continuous current path may be desired. In an embodiment, the magnetic switch 400 may be used as the mechanical switch 102 in the hybrid circuit breakers 200 of FIG. 2. In this embodiment, opening of the magnetic switch 400 may be performed under zero current or very low current conditions. The magnetic switch 400, however, may have load breaking capabilities. Thus, the magnetic switch 400 may be utilized in circuit breaker in which opening of the magnetic switch 400 is performed under load. For example, the magnetic switch 400 may be utilized as the mechanical switch 102 in the hybrid circuit breakers 100 of FIG. 1, in an embodiment. In other embodiments, the magnetic switch 400 may be utilized in circuit breakers configured differently from the hybrid circuit breakers 100, 200 of FIGS. 1 and 2, or may be utilized in suitable applications other than circuit breaker applications.

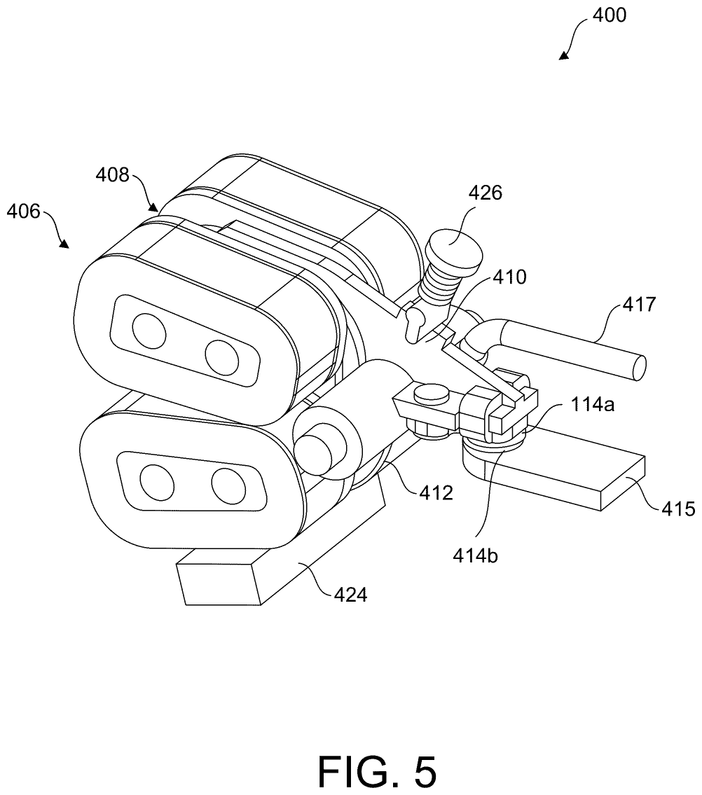

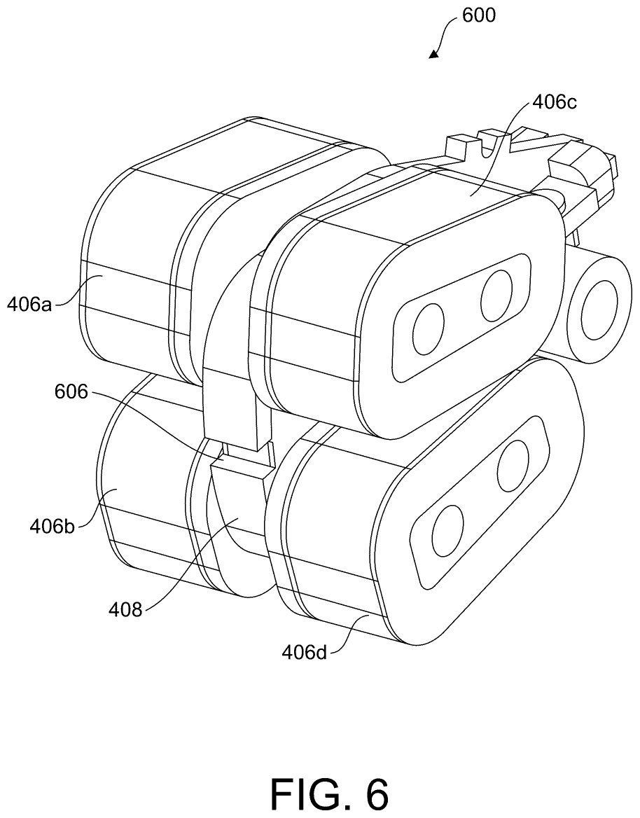

Referring to FIG. 4, the magnetic switch 400 includes a frame 402 having a first frame side 402a and a second frame side 402b. Various components of the magnetic switch 400 may be mounted between the first frame side 402a and a second frame side 402b of the frame 402. FIGS. 5 and 6 are views of components of the magnetic switch 400 with the frame 402 not shown for clarity. Referring to FIGS. 4-6, the magnetic switch 400 includes one or more driver coil assemblies 406 and a rotor assembly 408 comprising a rotor 410 and a movable coil assembly 412. The magnetic switch 400 further includes a movable electrical contact 414a provided on a movable backing 413 attached to the rotor 410 and a stationary electrical contact 414b provided on a fixed contact backing 415 separate from the rotor 410. The movable backing 413 may be staked and/or riveted to the rotor 410, for example. The fixed contact backing 415 may be made of a conductive material, such as copper, configured to conduct current between a first port or other contact (e.g., input port) of the magnetic switch 400 and the stationary electrical contact 414b. A flexible conducting component 417, such as a flexible copper braid, is coupled to the movable electrical contact 414a and is configured to conduct current between a second port or other contact (e.g., output port) of the magnetic switch 400 and the movable electrical contact 414a. The movable electrical contact 414a and the stationary electrical contact 414b may be made of a conducting material, such as silver tin oxide, that may be soldered, respectively, to the rotor 410 and the fixed contact backing 415, for example.

Rotation of the rotor 410 causes the rotor 410 to rotate between a closed position and an open position of the magnetic switch 400. In the closed position, the rotor 410 is positioned such that the movable electrical contact 414a presses against the stationary electrical contact 414b, and current may thus conducted between the movable electrical contact 414a presses against the stationary electrical contact 414b. In the open position, the rotor 410 is rotated such that the movable electrical contact 414a breaks apart from the stationary electrical contact 414b and an air gap is formed between the movable electrical contact 414a and the stationary electrical contact 414b.

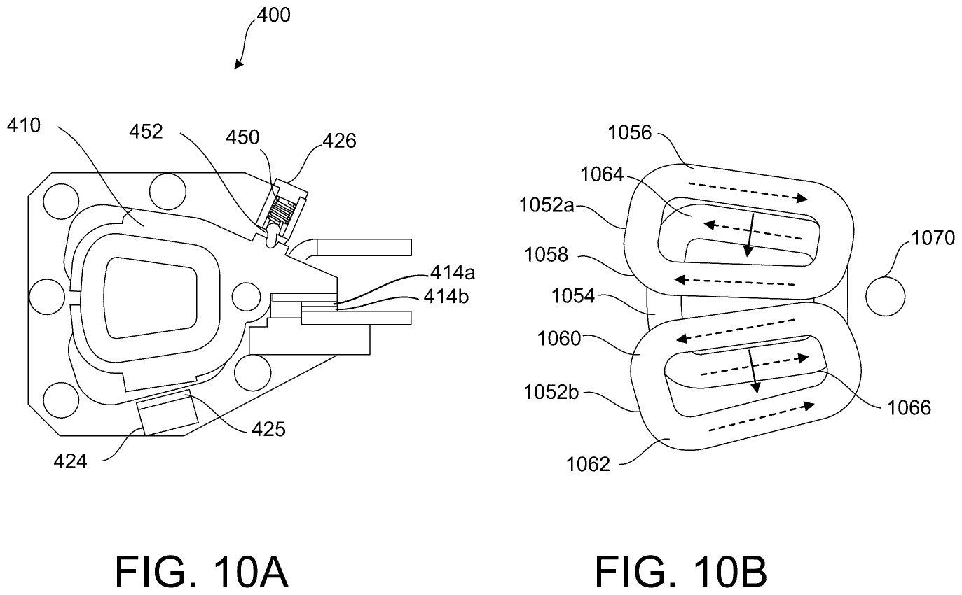

In an embodiment, the plurality of driver coil assemblies 406 and the movable coil assembly 412 are arranged in the magnetic switch 400 such that magnetic forces generated when current flows through coils of the plurality of driver coil assemblies 406 and the movable coil assembly 412 cause rotation of the rotor 410. For example, the driver coils of the driver coil assemblies 406 and the movable coil of the movable coil assembly 412 are electrically connected in series. The direction of winding of driver coils of the driver coil assemblies 406 and the movable coil of the movable coil assembly 412 is such that magnetic forces on the rotor 410 are in a direction to cause opening of the electrical contacts 414a, 414b. In an example, the movable coil assembly 412 comprises a voice coil configured to provide forward and backward motion of the movable coil assembly depending on a direction of current flow in the voice coil. In an example, the movable coil assembly 412 has at least approximately trapezoidal shape having a pair of relatively longer legs and a pair of relatively shorter legs. Magnetic flux generated when current flows through the plurality of driver coil assemblies 406 crosses the relatively longer legs of the movable coil assembly 412. The resulting magnetic forces, which are perpendicular to the relatively longer legs of the movable coil assembly 412, act in a direction that produces a rotational torque on the rotor 410. Direction of magnetic forces on the movable coil assembly 412 and resulting rotation of the rotor 410, according to an embodiment, are described in more detail below in connection with FIGS. 10A-111B.

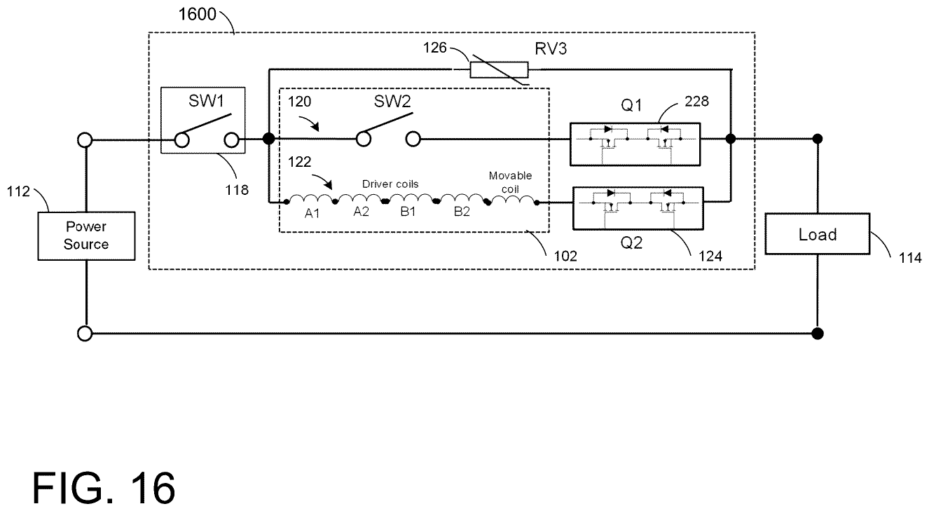

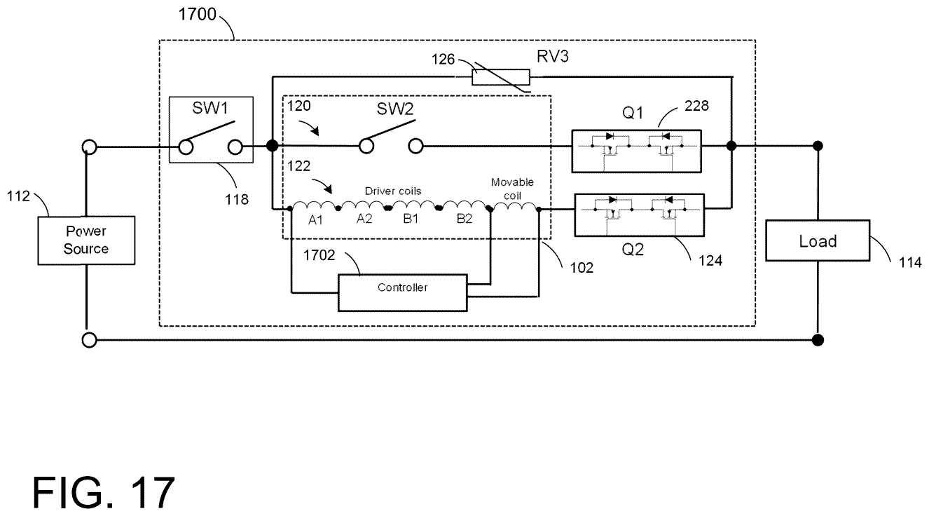

In an example in which the magnetic switch 400 is used as a mechanical switch in a continuous current path of a hybrid circuit breaker, the flexible conducting component 417, which may be welded to the movable backing 413, may connect the movable electrical contact 414a to the continuous current path of the hybrid circuit breaker. The fixed contact backing 415 may be connected to or otherwise be a part of the continuous current path of the hybrid circuit breaker, connecting the stationary electrical contact 114b to the continuous current path of the hybrid circuit breaker. The coils of the driver coil assemblies 406 and the movable coil assembly 408 may be wired in series in the bypass current path of the hybrid circuit breaker. Example hybrid circuit breakers equipped with a magnetic switch such as the magnetic switch 400, according to an embodiment, is described in more detail below with reference to FIGS. 16 and 17. In some embodiments, coils of the driver coil assemblies 406 and the movable coil assembly 408 may be wired in parallel, or a combination of series and parallel wirings may be utilized.

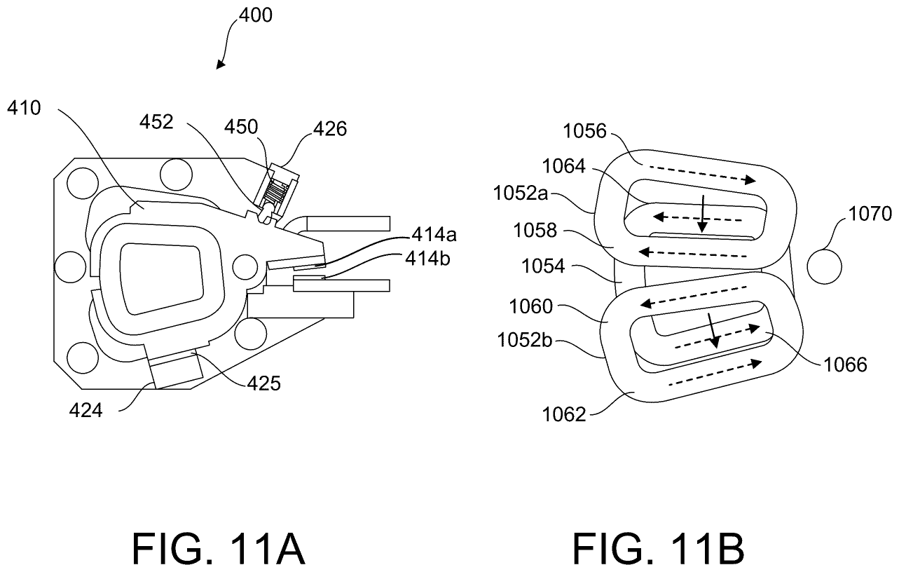

Referring now to FIG. 6, the driver coil assemblies 406 include four driver coil assemblies, including a first driver coil assembly 406a, a second driver coil assembly 406b, a third driver coil assembly 406c, a fourth driver coil assembly 406d, in the illustrated embodiment. As discussed in more detail below with reference to FIGS. 10A-11B, magnetic forces produced by the first driver coil assembly 406a and the second driver coil assembly 406b when current (e.g., short circuit current) flows through the first driver coil assembly 406a and the second driver coil assembly 406b act in a same direction on respective legs of the movable coil assembly 412. Similarly, magnetic forces produced by the third driver coil assembly 406c and the fourth driver coil assembly 406d when current (e.g., short circuit current) flows through the third driver coil assembly 406c and the fourth driver coil assembly 406d act in the same direction on respective legs of the movable coil assembly 412. The magnetic forces generated by the driver coils 406 in this manner cause movement of the rotor 410 in an opening direction of the magnetic switch 400.

With continued reference to FIG. 6, the first driver coil assembly 406a and the third driver coil assembly 406c are positioned on opposite sides of the driver coil assembly 412 relative to direction of movement of the driver coil assembly 412, in the illustrated embodiment. Similarly, the second driver coil assembly 406b and the fourth driver coil assembly 406d are positioned on opposite sides of the driver coil assembly 412 relative to direction of movement of the driver coil assembly 412, in the illustrated embodiment. In this configuration, balanced magnetic forces are generated that cross the driver coil assembly 412, resulting in no sideways forces on the movable coil assembly 412.

In other embodiments, one or more of the driver coils 406 illustrated in FIG. 6 may be omitted from the magnetic switch 400. Omitting one or more of the driver coils 406 illustrated in FIG. 6 may result in reduction of one or more of cost, size, weight, etc., of the magnetic switch 400. In an embodiment, the first driver coil assembly 406a and the second driver coil assembly 406b may be omitted from the magnetic switch 400 or the third driver coil assembly 406a and the fourth driver coil assembly 406b may be omitted from the magnetic switch 400. As another example, only a single driver coil assembly may be included to produce a sufficiently strong magnetic field for actuation of the magnetic switch 400. In such configurations, balancing of magnetic forces does not occur in the magnetic switch 400, which may result in sideways forces on the movable coil assembly 412. In an example, the movable coil assembly 412 may be designed to withstand the maximum sideways forces that may result from the unbalanced magnetic force arranged. Additionally, or alternatively, the magnetic switch 400 may be configured to allow the movable coil assembly 412 to be pulled towards and to slide against the driver coil assemblies 406. For example, a low friction insulating material, such as a Teflon film, may be placed between the movable coil assembly 412 and the driver coil assemblies 406 to allow the movable coil assembly 412 to be pulled towards and to slide against the driver coil assemblies 406.

In some embodiments, the magnetic switch 400 may include one or more additional driver coil assemblies not illustrated in FIG. 6. The one or more additional driver coil assemblies may be provided to increase the strength of the magnetic field generated for actuation of the magnetic switch 400 and, accordingly, to produce a faster opening time of the magnetic switch 400.

With continued reference to FIGS. 4-6, the magnetic fields generated by the driver coil assemblies 406 may cause driver coil assemblies 406 to be attracted to each other with strong magnetic forces and thus the driver coil assemblies 406 may be pulled in the direction towards each other, in some embodiments. For example, in the configuration illustrated in FIG. 6, the magnetic fields generated by the first driver coil assembly 406a and the third driver coil assembly 406c may cause the first driver coil assembly 406a and the third driver coil assembly 406c to be pulled towards each other. Similarly, the magnetic fields generated by the second driver coil assembly 406b and the fourth driver coil assembly 406d may cause the second driver coil assembly 406b and the fourth driver coil assembly 406d to be pulled towards each other. In an embodiment, a strong structural frame may be provided in the magnetic switch 400 to prevent driver coil assemblies from being pulled together and pinching the rotor assembly 408. For example, the frame 402, including the first frame side 402a and the second frame side 402b, may be made of a sufficiently strong material, such as ferromagnetic steel, for example. The coils in the driver coil assemblies 406 may be wrapped around bobbins that are mounted on strong driver cores, such as ferromagnetic steel driver cores. The driver cores may be fastened to the frame sides 402a, 402b with strong steel fasteners, such as SAE Grade 8 flat head socket screws. The driver cores may include flanges configured to retain the driver coils and prevent them from pulling together. In some embodiments, the frame sides 402a, 402b and driver cores of the driver coil assemblies 406 may be made from cold-worked or heat-treated steel for strength.

In an embodiment, because the frame sides 402a, 402b and cores and fasteners of the driver coil assemblies 406 are made from ferromagnetic steel, this increases and enhances the strength of the magnetic field generated when current flows through the driver coil assemblies 406. However, in at least some embodiments, the ferromagnetic properties are of secondary importance to the mechanical strength. In various embodiments, the driver coils of the driver coil assemblies produce magnetic fields far exceeding magnetic saturation of steel. In at least some embodiments, magnetic forces will be only marginally stronger because of the ferromagnetic material of the frame sides 402a, 402b and cores and fasteners of the driver coil assemblies 406. In some embodiments, the frame sides 402a, 402b and cores and fasteners of the driver coil assemblies 406 may be made from non-magnetic material, such as aluminum.

The frame sides 402a, 402b may be held apart by support components 422. The support components 422 may be made of a non-ferromagnetic material, such as aluminum, brass, plastic, or another suitable non-ferromagnetic material. Although the support components 422 are illustrated in FIG. 4 as being round posts by way of example, it is noted that any other suitable structure may be used. For example, a molded plastic component might be used. In some embodiments, the support components 422 may be made of a ferromagnetic material, such as steel. In such embodiments, the support components 422 may be positioned further away from the core flanges of the driver coil assemblies 406 to avoid loss of magnetic force.

In an embodiment, a substantially strong mechanical stop 424 may be provided to halt rotational motion of the rotor 410 at the open position of the magnetic switch 400. In some embodiments, a snubber of resilient, energy-absorbing material such as butyl rubber or polyurethane may be used to reduce impact forces and prevent rebound. The magnetic switch 400 may also include a toggle spring mechanism 426 configured to bias the rotor 410 in the closed and open positions of the magnetic switch 400. To properly bias the rotor 410 in the closed position, a spring of the toggle spring mechanism 426 may be sized to provide sufficient contact force for continuous current to flow through the electrical contacts 414a, 414b.

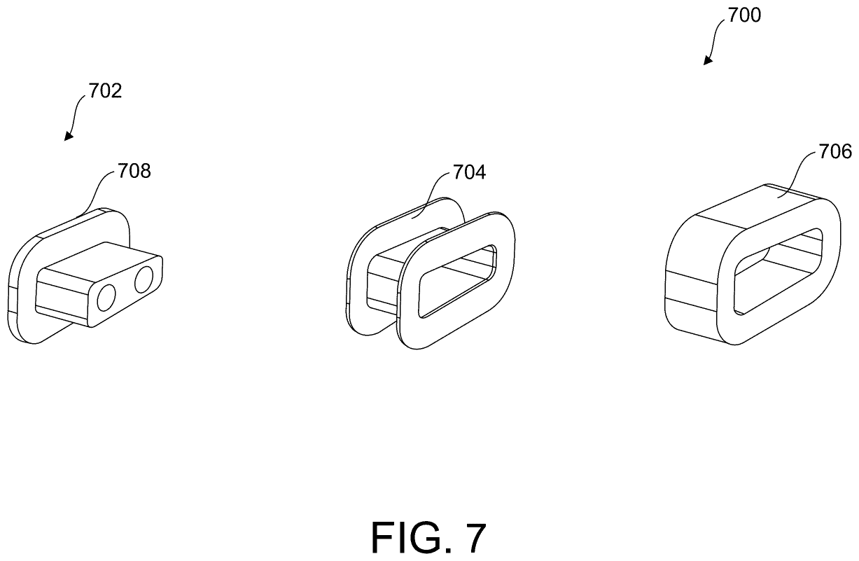

FIG. 7 is an expanded view of a driver coil assembly 700 that may be used with a magnetic switch equipped with a movable coil assembly and one or more driver coil assemblies, according to an embodiment. The driver coil assembly 700 corresponds to each of the driver coil assemblies 408 of the magnetic switch 400 of FIGS. 4-6, in an embodiment. The driver coil assembly 700 includes a core driver magnet 702, a bobbin 704 and a driver coil 706 that may be wound around the bobbin 704. The core driver magnet 702 may be made of a magnetic material, such as magnetic steel, for example. The core driver magnet 702 may include a flange 708. The flange 708 may be made of a strong material, such as steel, which may be sufficiently strong to withstand inward magnetic pull to prevent pinching of the rotor (e.g., the rotor 410) of the magnetic switch. The bobbin 706 may be made of plastic, for example. The driver coil 706 that may be wound around the bobbin 704 may be made of an insulated magnet wire.

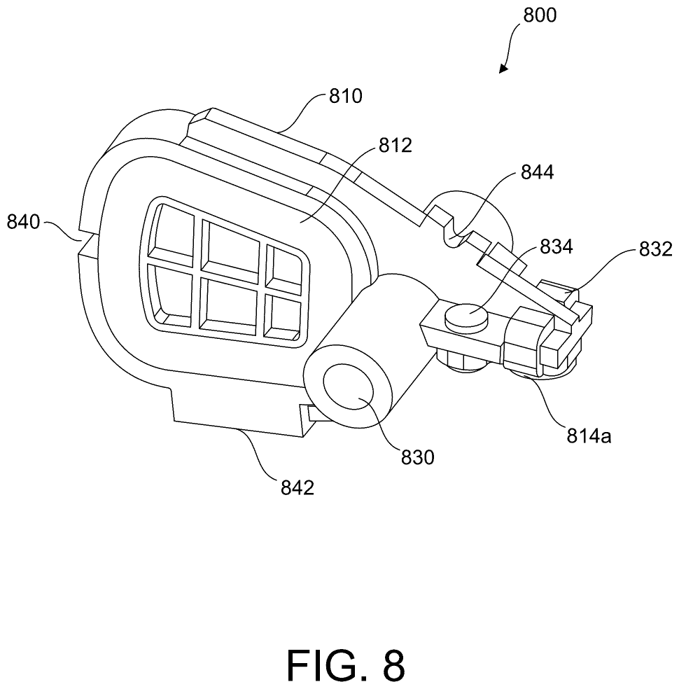

FIG. 8 is a view of a rotor assembly 800, according to an embodiment. In an embodiment, the rotor assembly 800 corresponds to the rotor assembly 408 of the magnetic switch 400 of FIGS. 4-6 and the rotor assembly 800 includes like-numbered elements with the rotor assembly 408 of the magnetic switch 400 of FIGS. 4-6. The rotor assembly 800 includes a rotor 810 mounted on, or otherwise attached to, a movable coil assembly 812. The rotor 810 is configured to rotate about a rotor pivot axis 830. A movable electrical contact 814a is provided on a backing 832 connected to the rotor 810 by a rivet 834. The rotor 810 may be made from a low density material, such as aluminum or reinforced plastic, to minimize rotational inertia of the rotor 810. In an embodiment in which the rotor 810 is made of a conducting material, such as aluminum, a break 840 may be provided in the structure to prevent eddy currents that would circulate in a direction opposite the direction of the current in the movable coil assembly 812 and slow down the opening speed of the magnetic switch. A portion 842 of the rotor 810 is enlarged to provide sufficient impact strength at a mechanical stop location on the rotor 810 when the rotor assembly 800 hits a mechanical stop (the mechanical stop 424 in FIG. 5) during opening of the magnetic switch. A notch 844 in the rotor 810 may provide a pivot point for a toggle lever (e.g., of the toggle spring mechanism 426 in FIG. 5) configured to bias the magnetic switch 400 in the opened or the closed position.

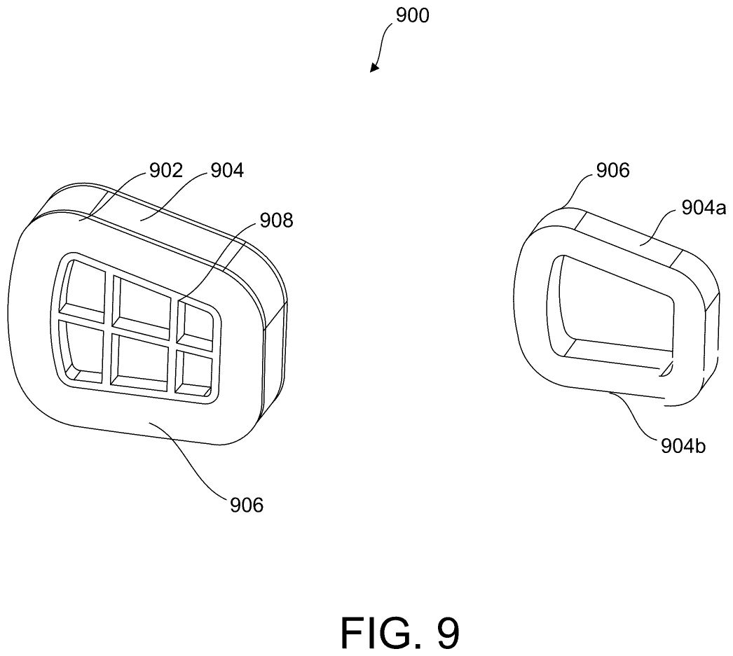

FIG. 9 is an expanded view of a movable coil assembly 900, according to an embodiment. The movable coil assembly 900 corresponds to the movable coil assembly 412 of the magnetic switch 400, according to an embodiment. The movable coil assembly 900 includes a bobbin 902 and magnetic coil 904 that is wound around the bobbin 902. The bobbin 902 may be made of a high strength plastic material. The bobbin 902 may include flanges 906 and a core 908. The flanges 906 may be provided to protect coil winding of the magnetic coil 904. The core 908 may be ribbed to enhance strength while minimizing inertia of the bobbin 902. The bobbin 902 may have at least approximately trapezoidal shape. Accordingly, the magnetic coil 904 wound around the bobbin 902 may form a first relatively long leg 908a and a second relatively long leg 908b. The first relatively longer leg 908a and the second relatively longer leg 908b may each be longer as compared to at least one relatively shorter leg 910 formed between the first relatively longer leg 908a and the relatively longer leg 908b.

FIG. 10A is a view of a cut section through the middle of the magnetic switch 400 in the closed position, according to an embodiment. FIG. 10B is a side view showing the direction of flow of current in coils of the magnetic switch 400 and the resulting magnetic forces as the magnetic switch 400 transitions from the closed position to an open position, according to an embodiment. Referring to FIG. 10A, in the closed position, the rotor 410 is positioned such that the movable electrical contact 414a presses against the stationary electrical contact 414b. A spring 450 of the toggle spring mechanism 426 biases a toggle level 430 to hold the rotor assembly 408 in the closed position.

Referring now to FIG. 10B, coils of the driver coil assemblies 406 and the stationary coil assemblies 408 are connected in series such that, when current flows through the coils, the positive direction of flow is as shown by the dashed arrows in the coils. In this arrangement, as shown in FIG. 10B, current flowing through a leg 1056 of the driver coil 406a and current flowing through a leg 1064 of the movable assembly 408 are in opposite directions, and current flowing through a leg 1058 the driver coil 406a and current flowing through the leg 1064 of the movable assembly 408 are in the same direction. Similarly, current flowing through a leg 1060 of the driver coil 406b and current flowing through a leg 1066 of the movable assembly 408 are in opposite directions, and current flowing through a leg 1062 of the driver coil 406b and current flowing through the leg 1066 of the movable assembly 408 are in the same direction. By application of the right hand rule, it can be seen that magnetic forces resulting from the current flow arrangement are as shown by the solid arrow in FIG. 10B. As shown in FIG. 10B, the resulting magnetic forces push down on the movable coil assembly 408, resulting in upward rotation of the rotor 410 and breaking apart of the movable electrical contact 414a from the stationary electrical contact 414b. Accordingly, flow of current in the coils of the driver coil assemblies 406 and the movable coil assembly 408 in the direction illustrated in FIG. 10B results in opening of the magnetic switch 400, in an embodiment.

FIG. 11A is a view of a cut section through the middle of the magnetic switch 400 in the open position, according to an embodiment. FIG. 11B is a side view showing the direction of flow of current in coils of the magnetic switch 400 and the resulting magnetic forces as the magnetic switch 400 reaches the open position, according to an embodiment. As shown in FIG. 11B, the magnetic forces resulting from the current flowing coils of the driver coil assemblies 406 act on the coils of the movable coil assembly 408 to cause the movable coil assembly 408 to rotate the rotor 410 to the open position of the magnetic switch 400. Referring now to FIG. 11A, in the open position, the rotor 410 is rotated such that the movable electrical contact 414a is separated from the stationary electrical contact 414b by an air gap, in an embodiment. The air gap may be relatively small, such as 1/16 of an inch, for example. In an embodiment in which the magnetic switch 400 is used as a mechanical switch in a continuous current path of a hybrid circuit breaker, the air gap may be sized to momentarily withstand the system voltage and any transients, for example, about 0.06 inches. In an embodiment in which the electrical contacts 414a, 414b are not subject to arcing (such as in the hybrid circuit breaker 200 of FIG. 2), this distance may be smaller than an air gap needed in a purely mechanical circuit breaker.

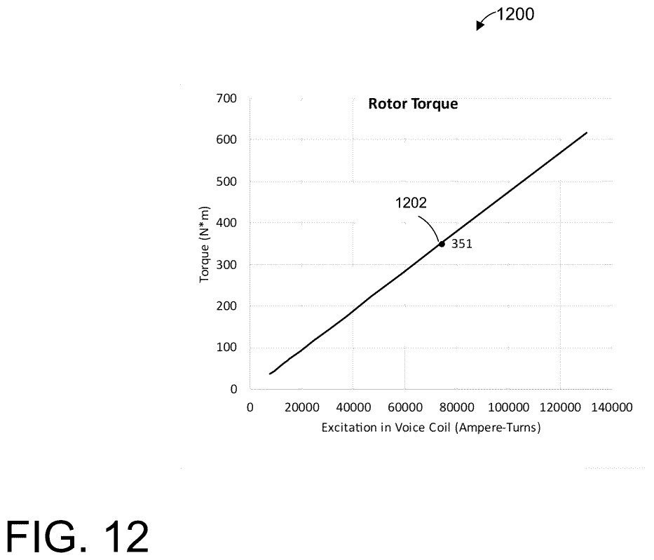

Referring briefly to FIG. 12, a simulation plot 1200 illustrates torque produced for actuating the magnetic switch 400 of FIG. 4, according to an embodiment. A point 1202 in the plot corresponds to 73970 ampere turns of excitation in the movable coil assembly 412 of the magnetic switch 400 with current of 850 A flowing through the coils of the driver coil assemblies 406 and the movable coil assembly 412. As shown in the plot 1200, the 73970 ampere turns of excitation results in 351 Newton-meters (N*m) of torque acting on the rotor 410. In an embodiment, to achieve 73970 ampere turns, each of the coils of the driver coil assemblies 406 and the movable coil assembly comprises 87 turns of #26 AWG wire.

In an embodiment in which the magnetic switch 400 is used as a mechanical switch in a continuous current path of a hybrid circuit breaker, the magnet wire used for the coils of the driver coil assemblies 406 and the movable coil assembly 412 are configured to carry fault current (e.g., short circuit current), but only for a short period of time (e.g., equal to or less than 100 μs). Further, because of the fast interruption of the fault current in the magnetic switch 400, current rises to a level much less than the peak available fault circuit current of the load circuit, in various embodiments. Accordingly, the magnet wire used for the coils of the driver coil assemblies 406 and the movable coil assembly 412 may be appropriately sized such that temperature rise in the magnet wire is limited to an acceptable level for the insulation material, under repeated overloads, in an embodiment. For example, in an embodiment in which threshold at which the current is diverted to the bypass current path of the hybrid circuit breaker is 850 A, #26 AWG wire size may be used for the magnet wire used for the coils of the driver coil assemblies 406 and the movable coil assembly 412. The number of turns in the magnet wire of the coils of the driver coil assemblies 406 and the movable coil assembly 412 may be selected to produce the required magnetic torque which is able to open the contacts within the required time, such as opening time equal to or of less than 100 μs.

Referring again to FIG. 11A, the mechanical stop 424 is provided to stop rotation of the rotor assembly 410. The mechanical stop 424 may be made of a strong material to withstand the movement of the rotor assembly 408 under strong magnetic forces generated when current flows in the driver coil assemblies 406. A snubber 425 may be provided on the mechanical stop 424 to absorb the shock resulting from the rotor assembly 408 hitting the mechanical stop 424. The snubber 425 may be made of an elastic material, such as rubber (e.g., butyl rubber) or polyurethane, for example. The toggle spring mechanism 426 is to bias the rotor assembly 408 in the open position.

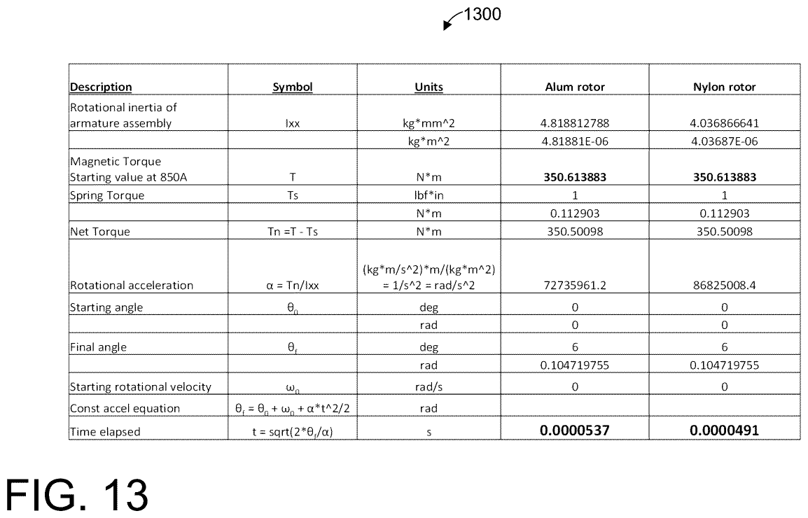

FIG. 13 is a table 1300 illustrating rotational inertias and switch opening times for the magnetic switch 400 of FIG. 4, according to an embodiment. The rotational inertias and switch opening times illustrated in the table 1300 correspond to an embodiment of the magnetic switch 400 with 351 Newton meters (N*m) of torque applied to the rotor 410, which may occur at 850 A of excitation current as illustrated in the plot 1200 of FIG. 12. The table 1300 includes a column 1302 that provides calculated values for the magnetic switch 400 with the rotor 410 made out of aluminum, and a column 1304 that provides calculated values for the magnetic switch 400 with the rotor 410 made out of nylon. As illustrated in the table 1300, an opening time of 53.7 μs may be achieved in the configuration of the magnetic switch 400 with the rotor 410 made out of aluminum and opening time of 49.1 μs may be achieved in the configuration of the magnetic switch 400 with the rotor 410 made out of nylon, in various embodiments.

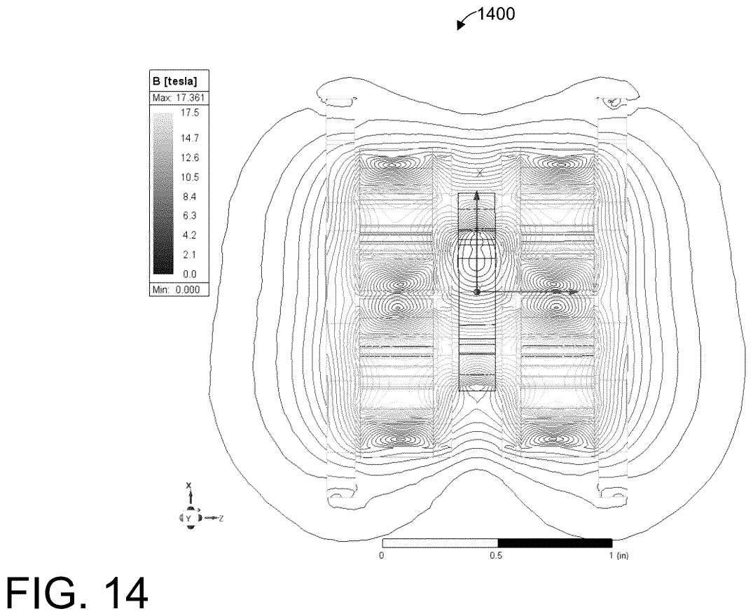

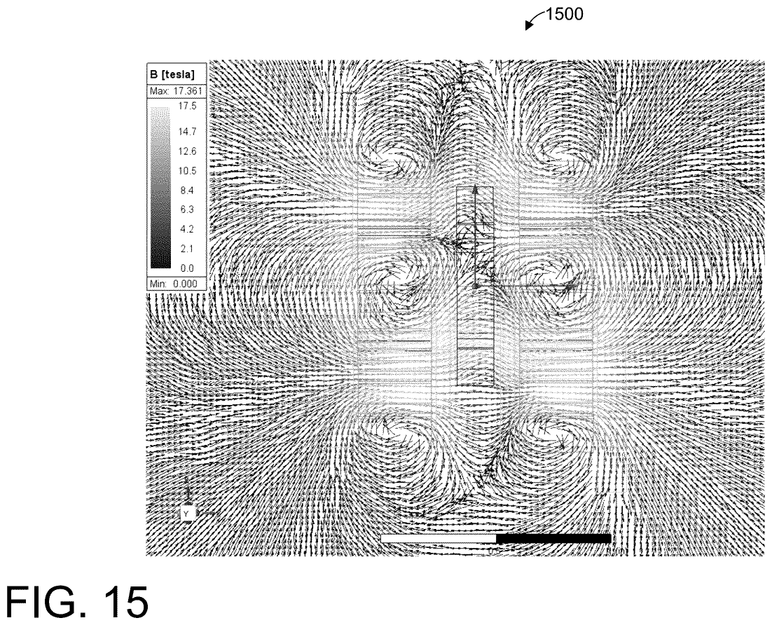

Referring briefly to FIGS. 14 and 15, simulation plots 1400 and 1500 depict magnetic field intensity and magnetic flux density, respectively, crossing the movable coil assembly 408 when coils of the driver coil assemblies 406 and the movable coil assembly 408 are energized in the magnetic switch 400 of FIG. 4, according to an embodiment. The plots 1400, 1500 correspond to 73950 ampere-turns excitation on the voice coil assembly 408 with corresponding rotator torque and opening times as illustrated in FIGS. 12 and 13, according to an embodiment. As shown by the plots 1400, 1500, the magnetic field strength and flux density crossing the movable coil assembly 408 in the magnetic switch 400 may exceed 17 Tesla (T), in an embodiment. Also, as shown by the plots 1400, with current in the positive direction, the magnetic flux crosses the movable coil assembly causing opening of the magnetic switch 400. In is noted, however, that by application of right-hand-rule of magnetic forces on electrical conductors, it can be seen that magnetic torque on the movable coil assembly is in an opening direction whether the current is positive or negative, in an embodiment.

FIG. 16 is a block diagram of a hybrid circuit breaker 1600 equipped with a mechanical switch, such as the magnetic switch of FIG. 4, in a continuous current path, according to an embodiment. The hybrid circuit breaker 1600 is generally the same as the hybrid circuit 200 of FIG. 2, in an embodiment. The hybrid circuit breaker 1600 includes a commutation switch such as the magnetic switch 400, in an embodiment. The magnetic switch 400 is wired in the hybrid circuit breaker 1600 such that the electrical contacts 414a, 414b are wired in the continuous current path 120 of the hybrid circuit breaker 1600, and the coils of the driver coil assemblies 406 and the movable coil assembly 408 are wired in series in the bypass current path 122 of the hybrid circuit breaker 1600. Thus, under normal operating conditions when the magnetic switch 400 is operated in the closed position, current flows through the electrical contacts 414a, 414b in the continuous current path 120, with no significant current flow in the coils of the driver coil assemblies 406 and the movable coil assembly 408 wired in series in the bypass current path 122. When a fault, such as short circuit, is detected and current is diverted from the continuous current path 120 to the bypass current path 122 by opening of the solid-state switch 228, current (e.g., short circuit current) begins to flow through the coils of the driver coil assemblies 406 and the movable coil assembly 408, actuating the magnetic switch 400 to transition to the open position. As discussed herein, the magnetic switch 400 may reach the open position relatively quickly, such as in 100 μs or less after begins to flow through the coils of the driver coil assemblies 406 and the movable coil assembly 408. When the magnetic switch 400 reaches the open position, a control signal is provided to the solid-state switch 124 in the bypass current path 200 to transition the solid-state switch 124 to an OFF state to extinguish the current. As discussed above, due to the fast opening time of the magnetic switch 400 in the hybrid circuit breaker 1600, current is extinguished by the solid-state switch 124 before the current reaches a high value. For example, current is extinguished at a value that does not greatly exceed (e.g., exceeds only by 1%, 2%, 3%, etc.) the threshold current value (e.g., 850 A) at which the current is diverted from the continuous current path 120 to the bypass current path 122, in an embodiment.

FIG. 17 is a block diagram of a hybrid circuit breaker 1700 equipped with a mechanical switch, such as the magnetic switch of FIG. 4, in a continuous current path, according to another embodiment. The hybrid circuit breaker 1700 is generally the same as the hybrid circuit breaker 1600 of FIG. 16, except that the hybrid circuit breaker 1700 includes a controller 1702 (e.g., a control circuit or other suitable form a controller) that is not included on the hybrid breaker 1600 of FIG. 16. The control circuit 1702 is configured to cause actuation of the magnetic switch 400 to reclose the magnetic switch 400, for example when the fault that caused tripping of the hybrid circuit breaker 1700 has been resolved. The controller 1702 is configured to apply current to the coils of the driver coil assemblies 406 and the movable coil assembly 408 such that resulting magnetic forces on the movable coil assembly 408 are in the opposite direction as compared the direction that causes opening of the magnetic switch 400. Thus, in an embodiment, the controller 1702 is configured to apply current to the coils of the driver coil assemblies 406 and the movable coil assembly 408 such that resulting magnetic forces on the movable coil assembly 408 are in the opposite direction as compared to the magnetic force direction that causes opening of the switch as illustrated in FIGS. 10B, 11B. For example, the controller 1702 applies current to the coils of the driver coil assemblies 406 the same direction as the current direction in the driver coil assemblies 406 illustrated in FIGS. 10B, 111B, and applies current to the coil of the movable coil assembly 408 such that the current flows in the opposite direction as compared to the current direction in the driver coil assemblies 406 illustrated in FIGS. 10B, 11B. In an embodiment, closing time of the magnetic switch 400 in the hybrid circuit breaker 200 is not as critical as the opening time of the magnetic switch 400 in the hybrid circuit breaker 200. Accordingly, the controller 1702 may actuate the magnetic switch 400 with a current that is relatively lower than the current (e.g., relatively lower than the short circuit current) that causes opening of the switch 400, in an embodiment. Transition of the magnetic switch 400 from the open position to the closed position may thus be performed with a magnetic field, and corresponding magnetic force, that is lower than the magnetic force that causes transition of the magnetic switch 400 from the closed position to the open position, in an embodiment.

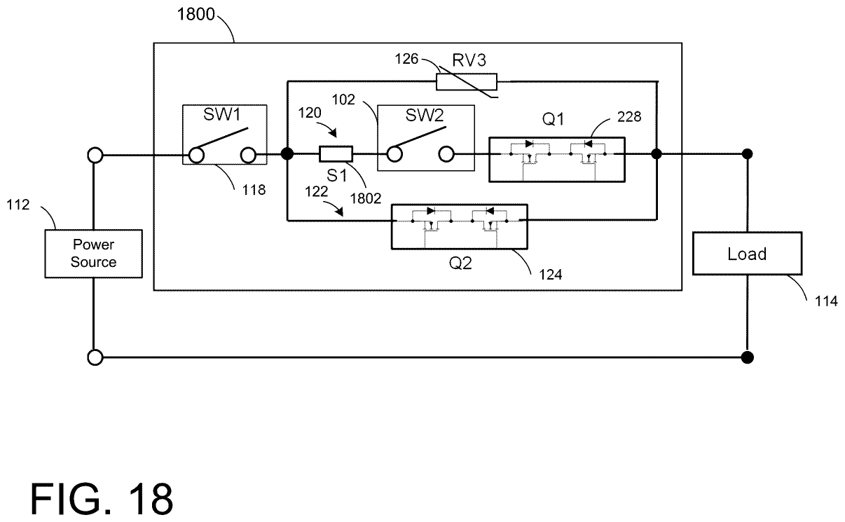

FIG. 18 is a block diagram of a hybrid circuit breaker 1800 equipped with a mechanical switch, such as the magnetic switch of FIG. 4, in a continuous current path, according to another embodiment. The hybrid circuit breaker 1800 is generally the same as the hybrid circuit breaker 200 of FIG. 2, except that the hybrid circuit breaker 1800 includes a current monitoring component 1802 that is not included in the hybrid circuit 200 of FIG. 2. The current monitoring component 1802 is provided in the continuous current path 120 of the hybrid circuit breaker 1800, in an embodiment. For example, the current monitoring component 1802 is coupled in the continuous current path 120 between an output of the isolation switch 118 and an input of the mechanical switch 102 in the continuous current path 120, in an embodiment. The current monitoring component 1802 may comprise a shunt, a Hall effect sensor, a current transformer, or another suitable type of a current monitoring device. The current monitoring component 1802 is configured to monitor the current at the input to the mechanical switch 102 to ensure that the mechanical switch 102 is not opened under load. In an embodiment, the mechanical switch 102 remains closed until the current monitoring component 1802 indicates that the current at the input to the mechanical switch 102 is below a predetermined threshold. The mechanical switch 102 may then be opened when the current monitoring component 1802 indicates that the current at the input to the mechanical switch 102 is dropped to or below the predetermined threshold.

In an embodiment, the current monitoring component 1802 ensures that the hybrid circuit breaker 1800 interrupts fault current, such as short circuit current, in a timely and controlled manner even when the solid-state switch 228 in the continuous current path 120 malfunctions and current is not properly commutated to the bypass current path 122 when a fault is detected. As an example, referring to the plot 350 of FIG. 3 in connection with the circuit breaker 1800, a fault may be detected a time t₀. At a time t₁, for example when short circuit current has risen to a value that exceeds a threshold value, such as 850 A, the solid-state switch 124 in the bypass current path 120 may be switched to a closed state. At a time t₂, which may occur a small increment Δt of time after t1, the solid-state switch 228 in the continuous current path 120 may be switched to an OFF state. If the current level monitored by the current monitoring component 1802 has drops to below a predetermined threshold, indicating that the solid-state switch 228 has functioned properly, the mechanical switch 102 may be controlled to be opened. In this case, the mechanical switch 102 opens under no load and zero, or nearly zero, current flowing through the mechanical switch 102. On the other hand, if the current monitored by the current monitoring component 1802 has not dropped below the predetermined threshold within a certain period of time, this indicates that the solid-state switch 228 has not functioned properly. In this case, the isolation switch 118 may be switched off to extinguish the fault current, as a backup for the hybrid circuit breaker 1800. In an embodiment, after current is extinguished by the isolation switch 118, the mechanical switch 102 in the continuous current path 120 may be opened. Because the fault current is extinguished by the isolation switch 118, the mechanical switch 102 in the continuous current path 120 may be opened under no load and zero, or nearly zero, current flowing through the mechanical switch 102, in an embodiment.

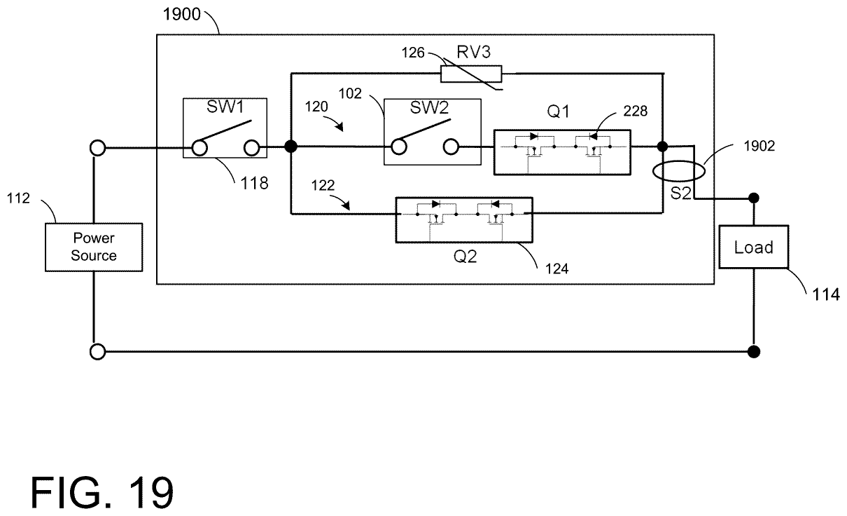

FIG. 19 is a block diagram of a hybrid circuit breaker 1900 equipped with a mechanical switch, such as the magnetic switch of FIG. 4, in a continuous current path, according to another embodiment. The hybrid circuit breaker 1900 is generally the same as the hybrid circuit breaker 1800 of FIG. 18, except that the current monitoring component 1802 provided in the continuous current path 120 of the circuit breaker 1800 is replaced by a differential current transformer 1902 coupled between the load 114 and the output of the bypass current path 122. The differential current transformer 1902 is configured to monitor a difference in current flowing to the load and the current flowing through the bypass current path 122. Under normal operation before a fault is detected, zero, or nearly zero, current is flowing through bypass current path 122. Accordingly, the differential current transformer 1902 generates a relatively large signal indicating a relatively big difference between the current flowing to the load 114 and the current flowing in the bypass current path 122. When fault is detected and the solid-state switch 228 in the continuous current path 120 is switched opened to divert the current to the bypass current path 122, all, or nearly all, current should be transferred to bypass branch. In this case, if the output signal of the differential current transformer 1902 drops to a predetermined threshold (e.g., at least approximately zero), this may indicate that the solid-state switch 228 in the continuous current path 120 has functioned properly. The mechanical switch 102 may then be controlled to be opened. In this case, the mechanical switch 102 opens under no load and zero, or nearly zero, current flowing through the mechanical switch 102. On the other hand, if the output signal of the differential current transformer 1902 has not dropped to the predetermined level within a certain period of time, this indicates that the solid-state switch 228 in the continuous current path 120 has not functioned properly. In this case, the isolation switch 118 may be switched off to extinguish the fault current, as a backup for the hybrid circuit breaker 1900. In an embodiment, after current is extinguished by the isolation switch 118, the mechanical switch 102 in the continuous current path 120 may be opened. Because the fault current is extinguished by the isolation switch 118, the mechanical switch 102 in the continuous current path 120 may be opened under no load and zero, or nearly zero, current flowing through the mechanical switch 102, in an embodiment.

While various embodiments of the disclosure have been described, it should be apparent to those of ordinary skill in the art that many more embodiments and implementations are possible that are within the scope of this disclosure. In addition, the various features, elements, and embodiments described herein may be claimed or combined in any combination or arrangement.

What is claimed is:

1. A magnetic switch, comprising
a frame,
one or more driver coil assemblies attached to the frame, the one or more driver coil assemblies including one or more driver coils,
a movable coil assembly, the movable coil assembly including a movable coil, and
a rotor mounted on the movable coil assembly, wherein the one or more driver coil assemblies and the movable coil assembly are arranged such that a magnetic field generated when current flows through the one or more driver coils of the one or more driver coil assemblies and the movable coil of the movable coil assembly generates a magnetic force that acts on the movable coil assembly in a direction to produce rotational torque of the rotor mounted to the movable coil assembly to cause actuation of the magnetic switch.

2. The magnetic switch of claim 1, wherein the movable coil assembly comprises a voice coil configured to provide forward and backward motion of the movable coil assembly depending on a direction of current flow in the voice coil.

3. The magnetic switch of claim 1, wherein:
the movable coil assembly comprises at least approximately trapezoidal shape having a first leg and a second leg, the first leg and the second leg being longer than a third leg that is between the first leg and the second leg, and
the one or more driver coil assemblies and the movable coil assembly are arranged such that the magnetic force generated when current flows through the one or more driver coils of the one or more driver coil assemblies and the movable coil of the movable coil assembly acts on the first leg and the second leg of the movable coil assembly to cause rotation of the rotor to actuate the magnetic switch.

4. The magnetic switch of claim 1, wherein the one or more driver coil assemblies include at least a first driver coil assembly and a second driver coil assembly, wherein the first driver coil assembly and the second driver coil assembly are positioned on opposite sides of the movable coil assembly such that the magnetic field generated when the current flows through driver coils of the first driver coil assembly and the second driver coil assembly on the opposite sides of the movable coil assembly are balanced with each other.

5. The magnetic switch of claim 4, wherein the frame is made of a ferromagnetic steel material to prevent the first driver coil assembly and the second driver coil assembly from being pulled towards each other by the magnetic field generated when the current flows through driver coils of the first driver coil assembly and the second driver coil assembly.

6. The magnetic switch of claim 1, wherein the one or more driver coil assemblies include at least a first driver coil assembly and a second driver coil assembly, wherein the first driver coil assembly and the second driver coil assembly are positioned on a first side of the movable coil assembly such that the magnetic field generated when the current flows through driver coils of the first driver coil assembly and the second driver coil assembly generate magnetic forces that act in a same direction on respective legs of the movable coil assembly.

7. The magnetic switch of claim 6, further comprising an insulating material placed between the movable coil assembly and the one or more driver coil assemblies to allow the movable coil assembly to be pulled towards and to slide against the one or more driver coil assemblies.

8. The magnetic switch of claim 6, wherein the one or more driver coil assemblies further include a third driver coil assembly positioned and a fourth driver coil assembly, wherein the third driver coil assembly and the fourth driver coil assembly are positioned on a second side of the movable coil assembly, the second side opposite of the first side of the movable coil assembly.

9. A hybrid circuit breaker, comprising
a first current path configured to conduct current from a power supply to a load under normal operating conditions,
a second current path configured as a bypass current path to which the current is diverted when a fault is detected,
a first solid-state switch in the second current path configured to extinguish the current diverted to the second current path, and
a magnetic switch configured to operate in a closed position to conduct the current from the power supply to the load, and switch to an open position to when the fault is detected, the magnetic switch including:
one or more driver coil assemblies, the one or more driver coil assemblies including one or more driver coils,
a movable coil assembly, the movable coil assembly including a movable coil, and
a rotor mounted on the movable coil assembly, wherein the one or more driver coil assemblies and the movable coil assembly are arranged such that a magnetic field generated when current flows through the one or more driver coils of the one or more driver coil assemblies and the movable coil of the movable coil assembly and generate a magnetic force that acts on the movable coil assembly in a direction to produce rotational torque of the rotor mounted to the movable coil assembly to cause the magnetic switch to switch from the closed position to the open position when the fault is detected.

10. The hybrid circuit breaker of claim 9, wherein the magnetic switch is wired such that, when the current is diverted from the first current path to the second current path, the current flows through the one or more driver coils and the movable coil to cause opening of the magnetic switch.

11. The hybrid circuit breaker of claim 9, wherein, when the current flows through the one or more driver coils and the movable coil, a strength of the magnetic field causes the magnetic switch to reach a fully open position before a maximum value of a fault current is reached.

12. The hybrid circuit breaker of claim 9, further comprising a second solid-state switch coupled in series with electrical contacts of the magnetic switch in the first current path, the second solid-state switch configured to, when the fault is detected, be switched to an OFF state to divert current to the second current path prior to opening of the magnetic switch.

13. The hybrid circuit breaker of claim 12, further comprising a backup mechanical switch coupled between an input contact of the hybrid circuit breaker and the first current path of the hybrid circuit breaker.

14. The hybrid circuit breaker of claim 13, further comprising
a current monitoring device configured to sense a change in current level due to opening of second solid-state switch, and
a controller configured to cause actuation of the backup mechanical switch if the change in current level indicates that the second solid-state switch has not functioned properly.

15. The hybrid circuit breaker of claim 14, wherein the current monitoring device is coupled in series with the second solid-state switch in the first current path of the hybrid circuit breaker, and wherein the current monitoring device is configured to sense a drop in current in the first current path due to due to the opening of second solid-state switch.

16. The hybrid circuit breaker of claim 14, wherein the current monitoring device comprises a differential current transformed configured to measure a difference in current at an output contact of hybrid circuit breaker and current flowing in the second current path.

17. The hybrid circuit breaker of claim 9, wherein:
the movable coil assembly of the magnetic switch comprises at least approximately trapezoidal shape having a first leg and a second leg, the first leg and the second leg being longer than a third leg that is between the first leg and the second leg, and
the one or more driver coil assemblies and the movable coil assembly of the magnetic switch are arranged such that the magnetic field generated when current flows through the one or more driver coils of the one or more driver coil assemblies crosses the first leg and the second leg of the movable coil assembly to cause rotation of the rotor to actuate the magnetic switch.

18. The hybrid circuit breaker of claim 9, wherein the one or more driver coil assemblies of the magnetic switch include at least a first driver coil assembly and a second driver coil assembly, wherein the first driver coil assembly and the second driver coil assembly are positioned on opposite sides of the movable coil assembly of the magnetic switch such that the magnetic field generated when the current flows through driver coils of the first driver coil assembly and the second driver coil assembly on the opposite sides of the movable coil assembly are balanced with each other.

19. The hybrid circuit breaker of claim 9, wherein the movable coil assembly of the magnetic switch comprises a voice coil configured to provide forward and backward motion of the movable coil assembly depending on a direction of current flow in the voice coil.

20. The hybrid circuit breaker of claim 19, further comprising a controller configured to re-close the magnetic switch by providing an excitation current to the one or more driver coil assemblies and the voice coil, wherein direction of excitation current provided to the voice coil is reversed relative to direction of current provided to the one or more driver coil assemblies.
